(19) United States
(12) Patent Application Publication
(10) Pub. No.: US 2013/0325682 A1
(43) Pub. Date: Dec. 5, 2013

(54) Systems For Associating Temporary Payment Cards With Financial Accounts

(71) Applicant: Unirush, LLC, Cincinnati, OH (US)

(72) Inventor: Scott Hakel, Milford, OH (US)

(73) Assignee: Unirush, LLC, Cincinnati, OH (US)

(21) Appl. No.: 13/904,668

(22) Filed: May 29, 2013

Related U.S. Application Data
(60) Provisional application No. 61/652,938, filed on May 30, 2012.

(51) Int. Cl. G06Q 40/02

(52) U.S. Cl. CPC G06Q 40/02
USPC 705/35

(57) ABSTRACT

Systems for associating temporary payment cards with financial accounts are provided. A system may utilize a processor to receive a financial account application, modify account data stored in a non-transitory memory component to create a financial account corresponding to the received financial account application, transmit instructions for picking up a temporary payment card from a retail location, and receive a temporary payment card registration message after the temporary payment card is picked up from the retail location. The temporary payment card registration message may include a unique identifier associated with the temporary payment card. The system may further utilize the processor to modify the account data in the non-transitory memory component to associate the temporary payment card with the financial account in response to receiving the temporary payment card registration message.

### CROSS-REFERENCE To RELATED APPLICATIONS

This application claims the benefit of U.S. Provisional Application No. 61/652,938, entitled “Methods and Systems For Associating Temporary Payment Cards Picked Up At Retail Locations With Existing Financial Accounts,” filed May 30, 2012.

### TECHNICAL FIELD

Embodiments provided herein generally relate to financial account administration systems, and more particularly to systems for associating temporary payment cards with financial accounts.

### TECHNICAL BACKGROUND

Financial accounts may be administered by one or more financial account administration systems. The financial account administration systems may track and modify information related to the financial account, such as the name of the account holder, an account balance, an account number or identifier, information related to payment cards associated with the account, and the like. In some instances, it may be desirable to use a temporary payment card in conjunction with the financial account.

Accordingly, a need exists for systems for associating temporary payment cards with financial accounts.

### SUMMARY

An individual or entity may wish to establish a financial account for a number of reasons, including, for example, in order to facilitate the transfer of funds from one party to another, to enable the tracking of purchases and/or fund transfers, to facilitate the easy access of funds, etc.

After determining that it would be desirable to establish a financial account, an individual or entity can establish a financial account in a number of ways. For example, an individual or entity can submit an application for a financial account to an account administrator via an in-person submission, via mail, via a website, over the phone, etc. If the account administrator determines that the applicant qualifies, the account administrator may establish a financial account that is associated with the individual or entity that applied for it. Once a financial account has been established, that established financial account is considered to be an “existing financial account,” as used herein.

An account holder may have an existing financial account (e.g., a credit card account, debit card account, or prepaid card account), but may not have an active personalized payment card that is associated with the account. There are at least two ways in which an account holder may not have an active personalized payment card associated with his or her account.

First, a customer may apply for a credit card, a debit card, or a prepaid card online or over the telephone. If the customer is approved for the card, an account may be opened for the customer. However, a customer who opens such an account online or over the telephone will generally not immediately have a physical card that is associated with their account.

Second, an account holder that had a physical credit card, debit card, or prepaid card that is associated with the account may need a replacement card (e.g., the account holder may have lost his current card or the account holder's current card may be expiring).

In either case, an account holder with an existing financial account may be given a choice to pick up a temporary payment card from a retail location for use until a personalized payment card arrives in the mail.

In one embodiment, a system for associating a temporary payment card with a financial account includes a non-transitory memory component, storing account data and a set of executable instructions, and a processor capable of executing the set of executable instructions. When executed by the processor, the set of executable instructions causes the system to receive a financial account application. The financial account application includes financial account application data. When executed by the processor, the set of executable instructions further cause the system to modify the account data stored in the non-transitory memory component to create a financial account corresponding to the received financial account application, transmit instructions for picking up a temporary payment card from a retail location, and receive a temporary payment card registration message after the temporary payment card is picked up from the retail location. The temporary payment card registration message includes a unique identifier associated with the temporary payment card. When executed by the processor, the set of executable instructions causes the system to modify the account data stored in the non-transitory memory component to associate the temporary payment card with the financial account in response to receiving the temporary payment card registration message.

In another embodiment, a system for associating a temporary payment card with a financial account includes a non-transitory memory component, storing account data and a set of executable instructions, and a processor capable of executing the set of executable instructions. When executed by the processor, the set of executable instructions causes the system to receive a financial account application. The financial account application includes financial account application data. When executed by the processor, the set of executable instructions further cause the system to determine whether to approve the creation of the financial account based on the received financial account application data, modify the account data stored in the non-transitory memory component to create a financial account corresponding to the received financial account application when the creation of the financial account is approved, transmit instructions for picking up a temporary payment card from a retail location, receive login information, verify that the login information corresponds to the financial account, and receive a temporary payment card registration message after the temporary payment card is picked up from the retail location. The temporary payment card registration message includes a unique identifier associated with the temporary payment card. When executed by the processor, the set of executable instructions further cause the system to modify the account data stored in the non-transitory memory component to associate the temporary payment card with the financial account in response to receiving the temporary payment card registration message when the login information is verified to correspond to the financial account.

In yet another embodiment, a system for associating a temporary payment card with a financial account includes a non-transitory memory component, storing account data and a set of executable instructions, and a processor capable of executing the set of executable instructions. When executed by the processor, the set of executable instructions causes the system to receive a financial account application. The financial account application includes financial account application data. When executed by the processor, the set of executable instructions further cause the system to modify the account data stored in the non-transitory memory component to create the financial account corresponding to the received financial account application, transmit instructions for picking up the temporary payment card from a retail location, and receive a temporary payment card registration message after the temporary payment card is picked up from the retail location. The temporary payment card registration message includes a unique identifier associated with the temporary payment card. When executed by the processor, the set of executable instructions further cause the system to modify the account data stored in the non-transitory memory component to establish a separate temporary payment card account associated with the temporary payment card in response to receiving the temporary payment card registration message, and modify the account data stored in the non-transitory memory component to transfer funds from the financial account to the separate temporary payment card account.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a schematic illustration of a system for associating temporary payment cards picked up at retail locations with existing financial accounts, according to one or more embodiments described and illustrated herein;

FIG. 2 depicts a schematic illustration of the server computing device of FIG. 1, further illustrating hardware and software that may be utilized in the server computing device, according to one or more embodiments described and illustrated herein; and

FIG. 3 depicts a flowchart of a method of associating temporary payment cards picked up at retail locations with existing financial accounts, according to one or more embodiments described and illustrated herein.

### DETAILED DESCRIPTION

The embodiments disclosed herein include systems for associating temporary payment cards with financial accounts. Systems for associating temporary payment cards with financial accounts, as described herein may include a non-transitory memory component, storing account data and a set of executable instructions, and a processor capable of executing the set of executable instructions. When executed by the processor, the set of executable instructions causes the system to receive a financial account application, modify the account data stored in the non-transitory memory component to create a financial account corresponding to the received financial account application, transmit instructions for picking up a temporary payment card from a retail location, receive a temporary payment card registration message after the temporary payment card is picked up from the retail location, and modify the account data stored in the non-transitory memory component to associate the temporary payment card with the financial account in response to receiving the temporary payment card registration message. Various embodiments of systems for associating temporary payment cards with financial accounts will be described in further detail herein with specific reference to the corresponding drawings.

It should be understood that embodiments of the present disclosure permit an account holder that does not have an active personalized payment card associated with his existing financial account to pick up a temporary payment card from a retail location and activate/associate the payment card with the existing financial account. Once the temporary payment card is associated with the account holder's existing financial account, the account holder can use the payment card in any situation in which a physical card may be required until a personalized payment card arrives in the mail.

As used herein, the term “payment card” refers to a prepaid card, a stored-value card, a credit card, a debit card, a charge card, a fleet card, a gift card, or any other similar article used to facilitate payment.

As used herein, the term “temporary payment card” refers to a non-personalized payment card that may be linked with an existing financial account. It should be understood that a temporary payment card may be continually used and is not limited to a particular duration of use. In some embodiments, an account holder's use of the temporary payment card may be limited in at least one way, such as to mitigate the risk of fraud. For example, in some embodiments, a limit on the amount that may be spent with the temporary payment card may be imposed, the categories of purchases that may be made with the temporary payment card may be limited, the temporary payment card may not be able to be used for withdrawal at an ATM machine, the amount that may be withdrawn from an ATM machine may be limited, and the like.

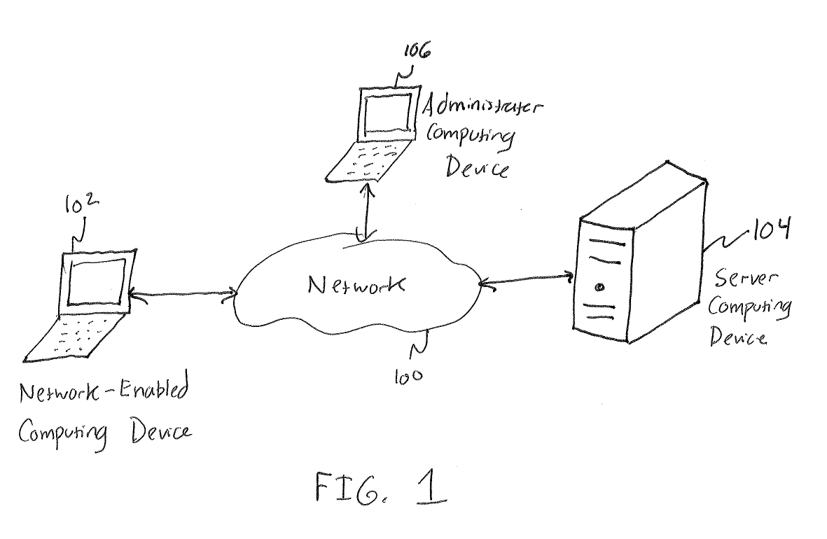

FIG. 1 depicts an exemplary computing network, illustrating components for a computing system for associating temporary payment cards picked up at retail locations with existing financial accounts, according to embodiments shown and described herein. The computing system illustrated in FIG. 1 generally comprises a computer network 100, network-enabled computing device 102, a server computing device 104, and an optional administrator computing device 106.

As illustrated in FIG. 1, computer network 100 may include a wide area network, such as the internet, a local area network (LAN), a mobile communications network, a public service telephone network (PSTN) and/or other network and may be configured to electronically connect the network-enabled computing device 102 with the server computing device 104.

The network-enabled computing device 102 may be a personal computer, a laptop computer, a server, a mobile device, a smartphone, a tablet device, a personal data assistant, a point of sale device, a computing device associated with a call center or IVR system, or any other device capable of electronically communicating with server computing device 104 via computer network 100. The network-enabled computing device 102 may be used at the direction/request of an account holder in order to send a message that facilitates the association of a temporary payment card, typically picked up by the account holder from a retail location, with an existing financial account of the account holder.

Similarly, the server computing device 104 may be operable to receive a request to associate a temporary payment card with an existing financial account of a particular account holder, and to associate the temporary payment card with the financial account in response to the request. In some embodiments, the server computing device 104 may be a component of an interactive voice response system or a website, though the embodiments described herein are not so limited.

Additionally, included in FIG. 1 is the optional administrator computing device 106. In the event that the server computing device 104 requires oversight, updating, or correction, the administrator computing device 106 may be configured to provide the desired oversight, updating, and/or correction. The administrator computing device 106, as well as any other computing device coupled to the computer network 100, may be used to transmit information to the network-enabled computing device 102 and/or the server computing device 104.

It should be understood that while the network-enabled computing device 102 and the administrator computing device 106 are depicted as personal computers and the server computing device 104 is depicted as a server, these are merely examples. More specifically, in some embodiments any type of computing device (e.g. mobile computing device, personal computer, server, smart phones, etc.) may be utilized for any of these components. Additionally, while each of these computing devices is illustrated in FIG. 1 as a single piece of hardware, this is also an example. More specifically, each of the network-enabled computing device 102, the server computing device 104, and the administrator computing device 106 may represent a plurality of computers, servers, databases, etc.

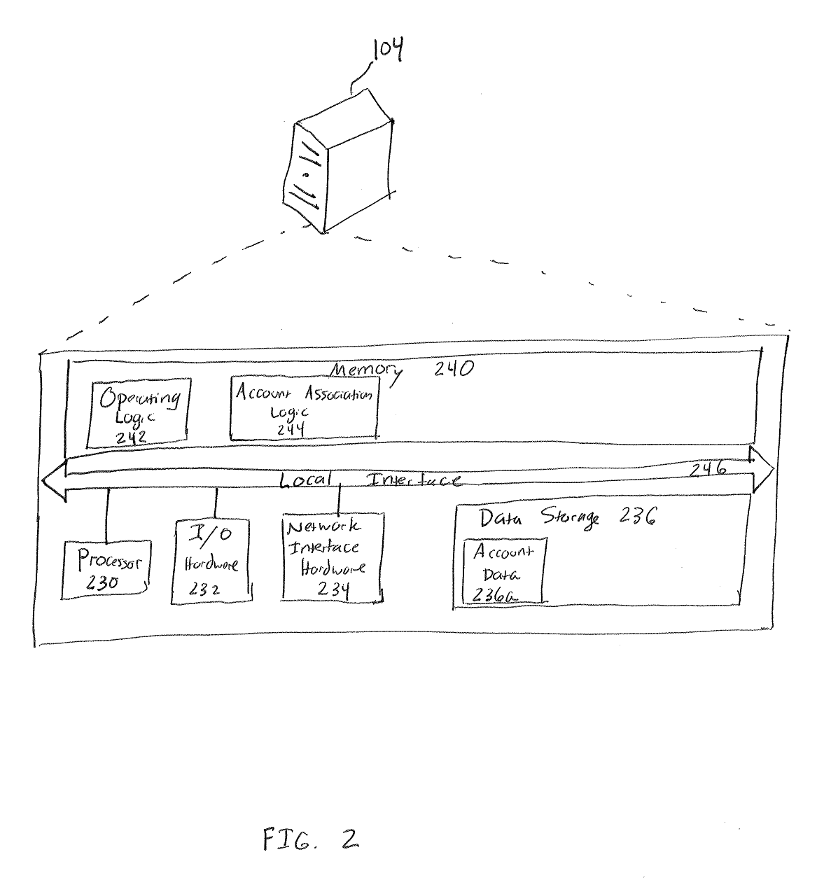

FIG. 2 depicts the server computing device 104, from FIG. 1, further illustrating a system for associating temporary payment cards picked up at retail locations with existing financial accounts, and/or a non-transitory computer-readable medium for associating temporary payment cards picked up at retail locations with existing financial accounts embodied as hardware, software, and/or firmware, according to embodiments shown and described herein. While in some embodiments, the server computing device 104 may be configured as a general purpose computer with the requisite hardware, software, and/or firmware, in some embodiments, that server computing device 104 may be configured as a special purpose computer designed specifically for performing the functionality described herein.

As also illustrated in FIG. 2, the server computing device 104 may include a processor 230, input/output hardware 232, network interface hardware 234, a data storage component 236 (which may store account data 236a), and a non-transitory memory component 240. The non-transitory memory component 240 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the non-transitory memory component 240 may be configured to store operating logic 242 and account association logic 244 (each of which may be embodied as a computer program, firmware, or hardware, as an example). A local interface 246 is also included in FIG. 2 and may be implemented as a bus or other interface to facilitate communication among the components of the server computing device 104.

The processor 230 may include any processing component configured to receive and execute instructions (such as from the data storage component 236 and/or non-transitory memory component 240). The input/output hardware 232 may include a monitor, keyboard, mouse, printer, camera, microphone, speaker, touch-screen, and/or other device for receiving, sending, and/or presenting data. The network interface hardware 234 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 236 may reside local to and/or remote from the server computing device 104 and may be configured to store one or more pieces of data for access by the server computing device 104 and/or other components. As illustrated in FIG. 2, the data storage component 236 may store account data 236a. The account data 236a may be stored in one or more data storage devices.

Account data 236a may contain data associated with a plurality of financial accounts. The account data associated with a particular financial account that is included in account data 236a may include: an account number or other unique identifier that enables the particular account to be differentiated from other accounts, the name of the entity or individual that holds the account, whether there are any payment cards associated with the account, an account balance, account transactions, and the number or unique identifier corresponding to each payment card associated with the account.

Included in the non-transitory memory component 240 are the operating logic 242 and the account association logic 244. The operating logic 242 may include an operating system and/or other software for managing components of the server computing device 104. Similarly, the account association logic 244 may reside in the non-transitory memory component 240 and may be configured to facilitate the association of a temporary payment card picked up at retail locations with an existing financial account.

It should be understood that the components illustrated in FIG. 2 are merely exemplary and are not intended to limit the scope of this disclosure. More specifically, while the components in FIG. 2 are illustrated as residing within the server computing device 104, this is a nonlimiting example. In some embodiments, one or more of the components may reside external to the server computing device 104. Similarly, while FIG. 2 is directed to the server computing device 104, other components such as the network-enabled computing device 102 and the administrator computing device 106 may include similar hardware, software, and/or firmware.

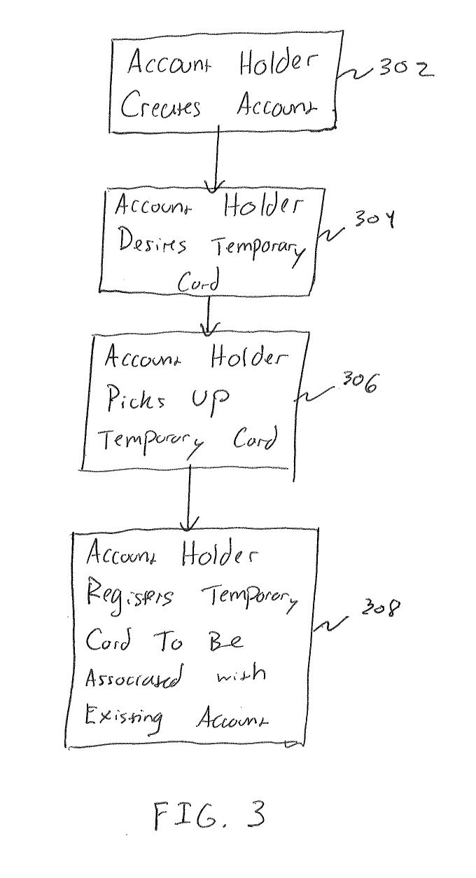

Referring now to FIG. 3, a flowchart of a method of associating temporary payment cards picked up at retail locations with existing financial accounts is depicted. In block 302, an account holder may create an account. The account holder may create the account by submitting a financial account application to an account-issuing entity via a variety of channels. The financial account application includes financial account application data, such as a name of the account holder, a social security number or other identifier associated with the account holder, a date of birth of the account holder, an income amount of the account holder, an address of the account holder, employment information related to the account holder, and the like. For example, the account holder may submit an financial account application via phone (e.g., through a call center or IVR system), or via internet (e.g., by utilizing a personal computer, laptop computer, smartphone, personal digital assistant, partner website, etc.). The server computing device 104 receives the financial account application including the financial account application data.

In some embodiments, the server computing device 104 determines whether to approve the creation of the financial account based on the received financial account application data. In some embodiments, the server computing device 104 may utilize the processor 230 to verify one or more pieces of financial account application data, for example to verify that the account holder name and account holder social security number or date of birth match.

After receiving the financial account application, the account-issuing entity may create a financial account in the name of the applicant (after approval, if applicable). For example, the server computing device 104 may utilize the processor 230 to modify the account data 236a in the non-transitory memory component 240 by adding the financial account to a plurality of financial accounts stored in the account data 236a. The server computing device 104 may also utilize the processor 230 to associate one or more pieces of information from the financial account application data with the added financial account. In embodiments in which the server computing device 104 utilizes the processor 230 to determine whether to approve the creation of the financial account, the server computing device 104 utilizes the processor 230 to modify the account data 236a to create the financial account after the creation of the financial account is approved.

In one embodiment, the account holder may establish a financial account associated with a prepaid debit card, a prepaid credit card, a credit card, or a debit card. When applying, the account holder may optionally add funds to the account if the account establishes a prepaid debit card or a prepaid credit card account, for example by transferring money from a checking account, from an existing stored value card, from another existing account, or the like. In embodiments in which the account holder adds funds to the account at the time of the creation, the server computing device 104 utilizes the processor 230 to modify the account data 236a to accordingly adjust an account balance associated with the created financial account.

Once the account is established, the account holder may desire a temporary payment card in block 304. An account holder may desire a temporary payment card for at least two reasons. First, the account holder may have recently established an account and may have not yet received a personal card associated with the account through the mail. Second, an account holder that at one time possessed a physical card associated with the account may need a replacement card (e.g., the account holder may have lost his or her current card or the account holder's current card may be expiring). It should be understood that the account holder may not desire to pick up a temporary payment card from the retail location if the account holder wishes to wait for a personalized payment card to arrive in the mail or if the account holder wishes to use the account without a payment cad.

The account holder may be prompted to indicate whether he or she desires to pick up a temporary payment card from a retail location when applying for the account. In some embodiments, the server computing device 104 may utilize the processor 230 to transmit a first prompt (e.g., for communication to the user by the network-enabled computing device 102) requesting whether a temporary payment card will be picked up. In response to the prompt, the account holder may indicate a desire to pick up the temporary payment card or a desire not to pick up the temporary payment card from a participating retail location. In some embodiments, the server computing device 104 may utilize the processor 230 to receive a first response (e.g., transmitted by the user from the network-enabled computing device 102) indicative of whether the temporary payment card will be picked up. The server computing device 104 may modify the account data 236a to track that the account holder indicated a desire to pick up a temporary payment card from a retail location.

Further, the account holder may be prompted whether the account holder wishes to have a personalized payment card mailed to him or her. For example, if the account holder intends to pick up a temporary payment card from a retail location and associate the temporary payment card with his or her account, the account holder may consider it unnecessary to receive a personalized payment card through the mail. In some embodiments, the server computing device 104 may utilize the processor 230 to transmit a second prompt (e.g., for communication to the user by the network-enabled computing device 102) requesting whether a personalized payment card should be mailed. In response to the prompt, the account holder may indicate a desire to have a personalized payment card mailed to an address associated with the financial account. In some embodiments, the server computing device 104 may utilize the processor 230 to receive a second response (e.g., transmitted by the user from the network-enabled computing device 102) indicative of whether the personalized payment card should be mailed. The server computing device 104 may modify the account data 236a to track that a personalized payment card should be mailed.

In some embodiments, a personalized payment card may be mailed or otherwise delivered to the account holder regardless of whether the account holder indicated a desire to pick up, or actually picked up, a temporary payment card from a retail location. In other embodiments, a personalized payment card may be mailed or otherwise delivered to the account holder if the account holder indicated a desire to pick up a temporary non-payment card from a retail location, but failed to pick up the temporary payment card within a predetermined time (e.g., within 1 day, 2 days, 3 days, a week, 2 weeks, etc.).

Furthermore, an account holder that desires a physical payment card may be given a choice to either pick up a temporary payment card from a retailer within a fixed period of time or to wait for a personalized payment card to arrive in the mail. In some embodiments, the server computing device 104 may utilize the processor 230 to transmit a third prompt (e.g., for communication to the user by the network-enabled computing device 102) requesting whether a picked up temporary payment card is desired or a mailed personalized payment card is desired. In response to the prompt, the account holder may indicate a desire to either pick up a temporary payment card or have a personalized payment card mailed. In some embodiments, the server computing device 104 may utilize the processor 230 to receive a third response (e.g., transmitted by the user from the network-enabled computing device 102) indicative of whether a picked up temporary payment card is desired or a mailed personalized payment card is desired. The server computing device 104 may modify the account data 236a to track whether a picked up temporary payment card is desired or a mailed personalized payment card is desired. In some embodiments, a personalized payment card may be sent to the account holder regardless of if the account holder chose to pick up and activate a temporary payment card from a retail location.

The server computing device 104 may utilize the processor 230 to transmit instructions for picking up a temporary payment card from a retail location. The instructions may include a series of steps instructing the account holder on the process for obtaining a temporary payment card from a retail location and associating the temporary payment card with an existing financial account (e.g., by logging into the account and providing a number or identifier associated with the temporary payment card, as described below). The instructions may also include a list of retail locations from which the temporary payment card may be picked up from (e.g., a general name of a retailer carrying temporary payment cards or specific locations carrying temporary payment cards). For example, in some embodiments, the server computing device 104 may utilize the processor 230 to transmit the temporary payment card pick up instructions to the network-enabled computing device 102, such as when an account holder applies for the financial account using a computer, a mobile telephone, or the like. In some embodiments, the instructions may be transformed from an electronic signal to an audible indication of the instructions (e.g., when audible instructions are generated and communicated for the account holder to hear) or a visual indication of the instructions (e.g., when visual instructions are generated and communicated for the account holder to read). In some embodiments, the server computing device 104 may transmit instructions for picking up a temporary payment card from a retail location in response to receiving a response indicating that the account holder desires to pick up at temporary payment card from a retail location.

In block 306, the account holder may pick up a temporary payment card from a retail location. The temporary payment card may be picked up from any retail location that participates in issuing or selling payment cards for association with the account holder's account. The location from which the temporary payment card will be picked up does not need to be known in advance in order to utilize the temporary payment card association system of the present disclosure. In one embodiment, the temporary payment card may contain a stored value and may be purchased from the retail location. In other embodiments, the account holder may pick up a temporary payment card from the retail location without purchasing the card or adding any value to the card or account at the time the card is picked up. The temporary payment card may have a card number or unique identifier that is not associated with the financial account before the temporary payment card is associated with the financial account. Thus, a random temporary payment card can be picked up from a participating retailer and associated with the financial account after the financial account is established.

In block 308, the account holder may register the temporary payment card to be linked with the account holder's existing account. Referring now to FIGS. 1 and 2, the account holder may directly utilize network-enabled computing device 102 to login to his or her account and associate the temporary payment card with the account holder's account by, for example, entering the card number or other unique identifier of the temporary payment card, scanning a barcode or near-field communication chip (e.g., RFID chip) on the temporary payment card or the temporary payment card packaging, or the like. It should be understood that the temporary payment card may be associated with the account holder's account in a variety of ways other than those specifically mentioned herein. In some embodiments, the user may login to the account by submitting log in information that is received by the server computing device 104. In such embodiments, the server computing device 104 may utilize the processor 230 to verify that the login information corresponds to the financial account.

Network-enabled computing device 102 may also be utilized to associate the temporary payment card with the account holder's account by the account holder calling in to a call center or IVR system or accessing a website, which in turn causes the temporary payment card to be associated with the account holder's account via the network-enabled computing device 102 operated by the call center or IVR system. The network-enabled computing device 102 may transmit a temporary payment registration message to the server computing device 104 via the computer network 100. The temporary payment card registration message may contain information necessary to associate the temporary payment card with the account holder's existing financial account. In one embodiment, the transmitted temporary payment card registration message may include the card number or other unique identifier of the temporary payment card. In another embodiment, the temporary payment card registration message may also include the account number or other unique identifier of the account holder's existing account.

Still referring to FIGS. 1 and 2, the server computing device 104 may receive the temporary payment card registration message containing the card number or other unique identifier of the picked up temporary payment card that the account holder desires to associate with his or her existing financial account. In response to receiving the temporary payment card registration message, the server computing device 104 may modify the account data 236a stored in the non-transitory memory component 240 such that the temporary payment card is associated or otherwise linked with the existing financial account of the account holder. In some embodiments, in response to receiving the temporary payment card registration message, the server computing device 104 may modify the account data 236a stored in the non-transitory memory component 240 to establish a separate temporary payment card account associated with the temporary payment card and transfer funds from the existing financial account of the account holder to the separate account for the temporary payment card. The account data 236a may be further modified by adding any stored value on the temporary payment card to the balance of the existing financial account, such as by accessing a database on the server computing device 104 or external to the server computing device 104 to determine a stored value associated with the temporary payment card. In embodiments in which the server computing device 104 verifies that the login information corresponds to the financial account, the server computing device 104 may only modify the account data 236a to associate the temporary payment card with the financial account when the login information is successfully verified.

Once the temporary payment card has been associated with the account holder's existing account, the account holder may utilize the temporary payment card to access the account or to engage in other activities for which a physical payment card may be required. In one embodiment, when the account holder uses the temporary payment card after it is associated with his or her account, a card use message may be transmitted to and received by server computing device 104. Server computing device 104 may access account data 236a to determine which account the card use message is associated with and to associate the card use message with the account associated with the temporary payment card.

It should now be understood that embodiments described herein provide for methods and systems for associating temporary payment cards picked up at retail locations with existing financial accounts. The temporary payment card association system of the present disclosure may benefit an account holder in several ways. For example, the temporary payment card association system of the present disclosure may allow an account holder to possess and use a physical payment card faster than waiting for a personalized payment card to arrive in the mail after establishing an account or requesting a replacement card, which in some instances, may take 7-10 days.

The temporary payment card association system also allows the temporary payment card to be picked up from any participating retail location, without knowing in advance which, if any, location that the temporary payment card may be picked up from.

Further, the temporary payment card association system of the present disclosure may enable an account holder to quickly cash a check. In one embodiment, a customer may establish a financial account, pick up a temporary payment card in a retail location, associate the temporary payment card with the account holder's established account, take a picture of a check to deposit into the account, and withdraw the money from an ATM machine without the wait associated with typical check cashing.

While particular embodiments have been illustrated and described herein, various other changes and modifications can be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for associating a temporary payment card with a financial account, the system comprising:
a non-transitory memory component, storing account data and a set of executable instructions, and a processor capable of executing the set of executable instructions, wherein, when executed by the processor, the set of executable instructions causes the system to:
receive a financial account application, wherein the financial account application includes financial account application data;
modify the account data stored in the non-transitory memory component to create the financial account corresponding to the received financial account application;
transmit instructions for picking up the temporary payment card from a retail location;
receive a temporary payment card registration message after the temporary payment card is picked up from the retail location, wherein the temporary payment card registration message includes a unique identifier associated with the temporary payment card; and
modify the account data stored in the non-transitory memory component to associate the temporary payment card with the financial account in response to receiving the temporary payment card registration message.

2. The system of claim 1, wherein, when executed by the processor, the set of executable instructions further cause the system to determine whether to approve the creation of the financial account based on the received financial account application data, wherein the account data is modified to create the financial account when the creation of the financial account is approved.

3. The system of claim 1, wherein, when executed by the processor, the set of executable instructions further cause the system to:
receive login information; and
verify that the login information corresponds to the financial account, wherein the account data is modified to associate the temporary payment card with the financial account when the login information is verified to correspond to the financial account.

4. The system of claim 1, wherein, when executed by the processor, the set of executable instructions further cause the system to:
transmit a first prompt requesting whether the temporary payment card will be picked up; and
receive a first response indicative of whether the temporary payment card will be picked up after transmitting the first prompt.

5. The system of claim 4, wherein, when executed by the processor, the set of executable instructions further cause the system to:
transmit a second prompt requesting whether a personalized payment card should be mailed; and
receive a second response indicative of whether the personalized payment card should be mailed after transmitting the second prompt.

6. The system of claim 1, wherein, when executed by the processor, the set of executable instructions further cause the system to:
transmit a second prompt requesting whether a personalized payment card should be mailed; and
receive a second response indicative of whether the personalized payment card should be mailed after transmitting the second prompt.

7. The system of claim 1, wherein, the instructions for picking up the temporary payment card from the retail location includes a list of retail locations from which the temporary payment card may be picked up from.

8. The system of claim 1, wherein the account data includes an account number or unique identifier, a name of an entity or individual, whether there are any payment cards associated with the account, an account balance, account transactions, or a number or unique identifier corresponding to each payment card associated with the account.

9. The system of claim 1, wherein, when executed by the processor, the set of executable instructions further cause the system to:
determine a temporary payment card stored value associated with the temporary payment card; and
modify the account data stored in the non-transitory memory component to increase an account balance of the financial account associated with the temporary payment card by the temporary payment card stored value.

10. The system of claim 1, wherein the unique identifier associated with the temporary payment card is not associated with the financial account before the temporary payment card is picked up from the retail location.

11. The system of claim 1, wherein the system is an interactive voice response system.

12. The system of claim 1, wherein the system is a website.

13. A system for associating a temporary payment card with a financial account, the system comprising:
a non-transitory memory component, storing account data and a set of executable instructions, and a processor capable of executing the set of executable instructions, wherein, when executed by the processor, the set of executable instructions causes the system to:
receive a financial account application, wherein the financial account application includes financial account application data;
determine whether to approve the creation of the financial account based on the received financial account application data;
modify the account data stored in the non-transitory memory component to create the financial account corresponding to the received financial account application when the creation of the financial account is approved;
transmit instructions for picking up the temporary payment card from a retail location;
receive login information;
verify that the login information corresponds to the financial account;
receive a temporary payment card registration message after the temporary payment card is picked up from the retail location, wherein the temporary payment card registration message includes a unique identifier associated with the temporary payment card; and
modify the account data stored in the non-transitory memory component to associate the temporary payment card with the financial account in response to receiving the temporary payment card registration message when the login information is verified to correspond to the financial account.

14. The system of claim 13, wherein, when executed by the processor, the set of executable instructions further cause the system to:
transmit a first prompt requesting whether the temporary payment card will be picked up; and
receive a first response indicative of whether the temporary payment card will be picked up after transmitting the first prompt.

15. The system of claim 14, wherein, when executed by the processor, the set of executable instructions further cause the system to:
transmit a second prompt requesting whether a personalized payment card should be mailed; and
receive a second response indicative of whether the personalized payment card should be mailed after transmitting the second prompt.

16. The system of claim 13, wherein, when executed by the processor, the set of executable instructions further cause the system to:
determine a temporary payment card stored value associated with the temporary payment card; and
modify the account data stored in the non-transitory memory component to increase an account balance of the financial account associated with the temporary payment card by the temporary payment card stored value.

17. The system of claim 13, wherein the unique identifier associated with the temporary payment card is not associated with the financial account before the temporary payment card is picked up from the retail location.

18. The system of claim 13, wherein the system is an interactive voice response system or a website.

19. The system of claim 13, wherein the account data includes an account number or unique identifier, a name of an entity or individual, whether there are any payment cards associated with the account, an account balance, account transactions, or a number or unique identifier corresponding to each payment card associated with the account.

20. A system for associating a temporary payment card with a financial account, the system comprising:
a non-transitory memory component, storing account data and a set of executable instructions, and a processor capable of executing the set of executable instructions, wherein, when executed by the processor, the set of executable instructions causes the system to:
receive a financial account application, wherein the financial account application includes financial account application data;
modify the account data stored in the non-transitory memory component to create the financial account corresponding to the received financial account application;
transmit instructions for picking up the temporary payment card from a retail location;
receive a temporary payment card registration message after the temporary payment card is picked up from the retail location, wherein the temporary payment card registration message includes a unique identifier associated with the temporary payment card;
modify the account data stored in the non-transitory memory component to establish a separate temporary payment card account associated with the temporary payment card in response to receiving the temporary payment card registration message; and
modify the account data stored in the non-transitory memory component to transfer funds from the financial account to the separate temporary payment card account.
